(19) United States
(12) Patent Application Publication
(10) Pub. No.: US 2007/0116852 A1
(43) Pub. Date: May 24, 2007

(54) Cattle feed preparation

(76) Inventor: Josef Schnatmann, Rietberg (DE)

Correspondence Address: JORDAN AND HAMBURG LLP, 122 EAST 42ND STREET, SUITE 4000, NEW YORK, NY, 10168, US

(21) Appl. No.: 11/285,861

(22) Filed: Nov. 22, 2005

(51) Int. Cl. A23K 1/00

(52) U.S. Cl. 426/635

(57) ABSTRACT

In order to embody a livestock feed preparation as dry feed for domestic livestock based on corn, grain, and feed supplements such that it at least increases the animals'resistance to illness, an additive of ground pepper is suggested that is black pepper ground in the usual manner, whereby the pepper additive is in the range of 30 g/t and 300 g/t.

### BACKGROUND OF THE INVENTION

The invention relates to a livestock feed preparation as dry feed for domestic livestock based on corn, grain, and feed supplements.

Feed preparations are known for dry feeds: they are generally based on shredded corn, various grains, sometimes with added soy, and frequently contain minerals as feed supplements. Although these known feeds are suitable for providing nutrition to animals, they do not contribute to resistance to illness nor to increasing vitality.

### SUMMARY OF THE INVENTION

Thus the object of the invention is to eliminate the disadvantages of the prior art and to suggest a livestock feed preparation that can also increase the animals'resistance to illnesses.

### DESCRIPTION OF THE PREFERRED EMBODIMENTS

In accordance with the invention, pepper is added to the feed preparation. Among known types of pepper, particularly suitable is black pepper that is obtained by drying harvested ripe fruits of Piper nigrum. The pepper, ground in the usual manner, is added to the feed preparation as a supplement. The quantity added ranges from 30 g/t to 300 g/t. The quantity added is advantageously 100 g/t to 200 g/t.

After this feed was administered, it was observed that the animals ate more feed. This appetite-promoting effect of pepper, known per se, leads to accelerated weight gain. Quite surprisingly, it was observed that the behavior of the animals changed, that they exhibited greater docility, that wounds healed faster, and that—observed over an extended period—the animals' susceptibility to illness decreased markedly. This held true not only for colds like runny noses and coughing, but also for other illnesses, so that veterinary treatment was required less frequently. Finally, the mortality rate decreased significantly.

In the observed inventory of 600 pigs, 1,000 kg feed preparation for pigs are used for dry feed daily. Initially 50 g black pepper were added to this quantity. This black pepper was ground in a conventional manner and added to the feed preparation. In a second phase, the pepper supplement was increased to 200 g ground black pepper for 1,000 kg feed preparation for pigs.

Use of the dry feed preparation with the pepper added demonstrated surprising success: the fattening animals ate approximately 0.5 kg more dry food per day. Maturation for slaughter, which is reached after 160-180 days, occurred about 10 days sooner. In addition to increased food intake, a change in the behavior of the pigs in the stall was observed: they were less excited and no longer exhibited the frenetic activity that was seen in the stall prior thereto.

The health of the fattening animals improved due to feeding dry feed with the pepper additive. Colds, which otherwise could hardly be avoided in the damp/cold months, were nearly non-existent in the 600 pigs in the fattening stall. It was possible to substantially reduce the amount of veterinary care and the administration of medications due to the use of dry feed with the pepper additive.

Finally, the loss of fattening animals due to death decreased: without the pepper added, approximately 2.5% of the fattening animals did not reach maturation for slaughter due to death. In one six-month fattening period with dry feed with the pepper added, out of 200 fattening animals only one expired prematurely, and it had already previously been susceptible to respiratory ailments. Deaths due to acute illnesses, which would otherwise not have been avoided, were no longer observed.

The use of this livestock feed preparation, even in other types of animals, permits both an increase in feed intake and resistance to illnesses.

1. Livestock feed preparation for use as a dry feed for domestic livestock comprising a livestock feed preparation selected from the group consisting of corn, grain, and feed supplements, and further comprising pepper.

2. Livestock feed preparation in accordance with claim 1, wherein the pepper comprises black pepper.

3. Livestock feed preparation in accordance with claim 1, wherein said pepper is pepper ground in the usual manner.

4. Livestock feed preparation in accordance with claim 1, wherein the pepper is in the range of 30 g/t to 300 g/t of the livestock feed preparation.

5. Livestock feed preparation in accordance with claim 4, wherein the pepper is between 100 g/t and 200 g/t of the livestock feed preparation.

6. Livestock feed preparation for use as a dry feed for domestic livestock comprising a livestock feed preparation selected from the group consisting of corn, grain, and feed supplements, and further comprising a veterinary medically effective amount of black pepper in the range of 30 g/t to 300 g/t of livestock feed preparation.

7. Livestock feed preparation in accordance with claim 6, wherein said pepper is pepper that is ground in the usual manner.

8. Livestock feed preparation in accordance with claim 6, wherein the pepper is between 100 g/t and 200 g/t of livestock feed preparation.

9. Animal feed preparation comprising a dry feed selected from the group consisting of corn, grain and feed supplements, and further comprising an immunostimulant additive which comprises pepper.

10. Animal feed preparation in accordance with claim 9, wherein said immunostimulant additive is black pepper.

11. Animal feed preparation in accordance with claim 9, wherein said pepper is pepper ground in the usual manner.

12. Animal feed preparation in accordance with claim 9, wherein said pepper is in the range from 30 g/t to 300 g/t of animal feed preparation.

13. Animal feed preparation in accordance with claim 12, wherein said pepper is between 100 g/t and 200 g/t of animal feed preparation.

14. Method for increasing endogenic resistance in animals by means of immunostimulation, comprising administering said immunostimulation by means of an animal feed preparation in accordance with claim 9.
